(19) United States
(12) Patent Application Publication
(10) Pub. No.: US 2004/0052889 A1
(43) Pub. Date: Mar. 18, 2004

(54) Procedure for the manufacture of paint rollers comprised of a polyolefin core covered with a pilose fabric

(75) Inventor: Alessandro Nespoli, Barcelona (ES)

Correspondence Address: Arent Fox Kintner Plotkin & Kahn, Suite 400, 1050 Connecticut Ave., NW, Washington, DC, 20036-5339, US

(73) Assignee: Nespoli Engineering Trade Limited Liability Company

(21) Appl. No.: 10/461,351

(22) Filed: Jun. 16, 2003

(30) Foreign Application Priority Data
Sep. 16, 2002 (ES) 200202122

(51) Int. Cl. B29C 43/08

(52) U.S. Cl. 425/366; 425/302.1

(57) ABSTRACT

A procedure for the manufacture of paint rollers comprised of a polyolefin core covered with a pile fabric consisting of tubular bodies similar in length made of polyolefins which are held in place by supports in the form of cylindrical bodies which may or may not be hollow. A mechanism at one end of the machine generates a lengthwise shifting and spiral rotational movement. A heat source softens the surface of the tubular body and incorporates a mechanism which generates the spiral rolling of a fabric cover on the tubular body softened on the outside.

### OBJECT OF THE INVENTION

The present descriptive account is related to a procedure for the manufacture of paint rollers comprised of a polyolefin core covered in a pile fabric, the end purpose of which lies in the fact that the tube, during the application of heat at a high temperature for a short time to cause the melting of the outer surface of the tube and during the winding of the fabric, is not threaded on a metal mandrel as previously, therefore being configured as a totally continuous manufacturing procedure and the covering being provided continuously with the tube crossing over the point generating heat and the station or fabric placement part on the extended tube.

The tube is threaded on the machine from one side to the other at an appropriate distance so that the fabric is extended covering the tube without any break in the winding.

In short, this invention is based on the fact that the tube per se, during the heat application stage and during the fabric winding stage, is not threaded directly on a metal mandrel, as is the case previously, but is rather a matter of a continuous procedure which makes it possible to thread the tubes through the heat and the station or stage where the fabric is placed on the tube proper made of plastic material, allowing the tubes to move one after the other at an appropriate distance so that the band of fabric can go from one tube to the other without there being any halt in the fabric winding or covering stage.

The invention entails the fact of propelling the tubes on which the fabric covering is being joined in a traveling and, at the same time, a rotating movement for the purpose of achieving a spiral movement of the tube along its center line.

The present invention is equipped with a device that can cut the fabric covering applied onto the body made of plastic material once the dimensions thereof have exceeded the cutting area. The cutting device cuts the fabric wound around the tubes in a gap between two advancing tubes. Then, the tube that is wound with the fabric is taken out of the machine manually or automatically. The following tube, which is in the process of being wound with fabric, continues in its lengthwise traveling movement and, at the same time, rotates with respect to the center line of the tube up to the cutting moment, thereby resulting in a spiral movement, which facilitates the application of the fabric covering.

### FIELD OF THE INVENTION

This invention is applicable within the industry dealing in the manufacture of paint rollers.

### BACKGROUND OF THE INVENTION

The applicant has no knowledge as to the current existence of any invention which is of the characteristics described in this descriptive account.

The applicant is aware of the existence of some Patents or Utility Models for which application has been filed under the name of Biancamaria, Alvarez-Garcia, Newell, and Sekart.

The Patents for which application has been filed under the name of Newell and under the name of Sekart are quite similar, given that they employ strips of polypropylene for manufacturing the tube, its process being continuous.

The Patent for which application has been filed under the name of Biancamaria employs the tube fabricated in line by means of an extruder with rotating drawplate, and the tube turns on its center line as it is extruded, consequently moving along with a spiral movement, being a continuous process.

The Patent for which application has been filed under the name of Alvarez-Garcia employs a pre-extruded tube and is not configured as a continuous process.

It would be desirable to avail of a Patent such as that which is described in the present descriptive account, characterized due to the fact that, although pre-extruded tubes are employed, the process is continuous, which is possible thanks to the fact that the tubes are not threaded on a mandrel, contrary to the case of the aforementioned Patents which employ polypropylene strips, such as is the case of the aforesaid Newell and Sekart Patents, in which the mandrel serves as a “mold” in order to be able to appropriately shape the strips which are progressively rolled and as cooling.

In the Patent for which application has been made under the name of Alvarez-Garcia, the mandrel serves to support the tube and is responsible for the rotating movement of the tube, also effecting the fact that the tube, during the heat-application phase, instead of losing its shape, remains rigid thanks to the action of the cooling device inside the mandrel, although no mention is made thereof in the aforesaid Patent.

In the Patent for which application has been filed under the name of Biancamaria, the mandrel serves to support the tube, being responsible for the circular component of the spiral movement, and serves the purpose of cooling or rather solidifying the tube.

The Patent for which application has been filed under the name of Biancamaria is currently in the public domain and employs heat to join the fabric, just the same as that of Newell patent and that of Alvarez-Garcia, whilst the Patent for which application has been filed under the name of Sekart employs fused polypropylene.

It would be desirable, precisely as has previously been stated, to avail of a Patent such as that which is described in this descriptive account, which employs heat, a characteristic currently in the public domain, and which, nevertheless, does not employ any type of mandrel, this characteristic of not employing any type of mandrel being the innovative element, given that it affords the possibility of converting the process into a continuous process, increasing the manufacturing capacity.

The fact of not employing any type of mandrel is possible due to the heat being applied more violently in this process, in other words, it is applied directly onto the body of the cylinder which is going to receive on the tube surface the body of the fabric material, achieving that the tube surface liquefies or melts or at least dissolves partially without the inside, in other words, the area comprising the cylinder, located on the interior, losing its consistency or rigidity, which leads to no need for any type of cooling means whatsoever being involved.

Therefore, the invention described in this descriptive account is, in terms of the fact that all is a consequence of a new method for configuring paint rollers, in accordance with the application of heat in a completely different manner.

### SUMMARY OF THE INVENTION

The invention is a procedure for the manufacture of paint rollers comprised of a polyolefin core covered with a pile fabric in which the invention has a mechanism which pushes the tube across the heating point and, at the same time, the fabric-applying station, propelling a spiral movement along the entire center line of the tube, which facilitates the movement of the hollow tubular body without the need of a supporting mandrel whatsoever on the inside thereof.

Both the mechanisms for the lengthwise thrusting and rotational movement of the cylindrical body made of plastic material and hollow inside, which is covered in fabric material by way of the action of the heating point, as well as the guiding of the fabric and the cutting element, are located on the frame of the machine.

The aforementioned movements can be achieved by way of several different embodiments.

In one embodiment, the present invention is directed to a mechanism which thrusts the tube, which will subsequently be used as a nexus for covering the fabric, through the heat source in which the tube is heated. Then, the mechanism thrusts the tube through a fabric-applying area where a fabric covering is applied thereto. During the heating and covering process, the tubular body to which the fabric is applied moves spirally on its center line.

The invention likewise has a mechanism which removes the tube duly covered in the fabric from the area in which the heat-generating element is located and from the area where the fabric is applied to the tube surface duly heated by the effect of the heat. This mechanism, like the aforementioned ones, ensures a traveling and rotating movement of the tube, always in the same direction, along its entire center line.

It must be said that both the heat-generating mechanism and the fabric guide are affixed to the frame of the machine.

The invention is equipped with a cutting mechanism which automatically makes the cut of the fabric covering when the hollow tubular body reaches a point in its traveling movement which requires being separated from the tube moving along behind it which is undergoing the same application.

Afterward, the tubular bodies covered in fabric material will be put through the pertinent cutting operations in accordance with the paint roller bodies which are required.

### BRIEF DESCRIPTION OF THE DRAWINGS

In order to complete the description which is being provided and for the purpose of aiding toward a better comprehension of the characteristics of the invention, a set of drawings is attached to the present descriptive account as an integral part thereof, showing, on an illustrative and non-limiting basis, the following:

FIG. 1 provides a simplified view of the machine of the invention;

FIG. 2 shows one possible embodiment of the mechanisms responsible for the movement of the tubular bodies along their entire center lines;

FIG. 3 shows a second embodiment of the devices shown in FIG. 2;

FIG. 4 is a front and side view of a third embodiment of the devices shown in FIGS. 2 and 3;

FIG. 5 is, once again, a fourth embodiment of the devices shown in FIGS. 2, 3 and 4; and

FIG. 6 shows two possible embodiments of the guides affixed to the machine frame.

### DETAILED DESCRIPTION OF THE PREFERRED EMBODIMENTS

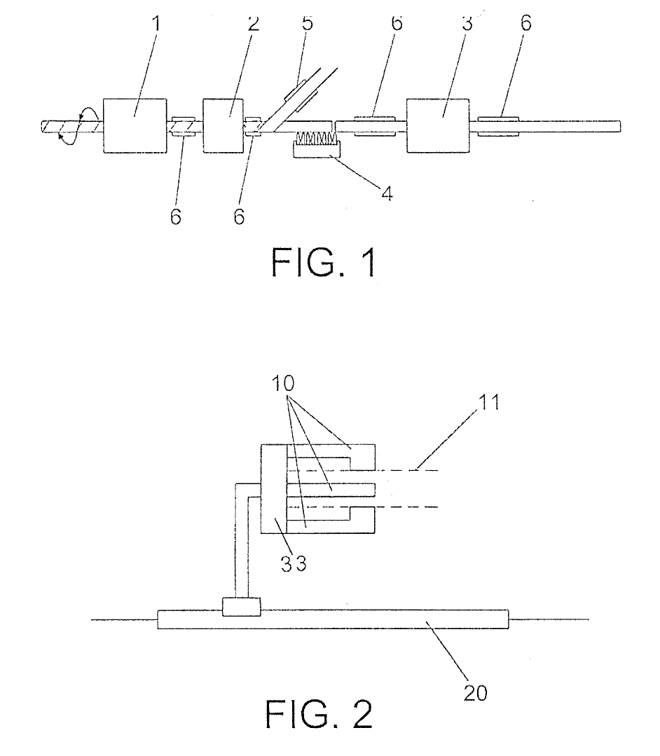

Following FIG. 1, it can be seen how the mechanisms 1 and 3 are those responsible for the spiral movement of the tubular bodies along their entire center lines, it necessarily being said that mechanism 1 must be affixed to the frame of the machine and placed following the cutting device 2 in relation to the moving direction in which the tubes travel.

Device 3 must be placed prior to the fabric-covering station 5 and affixed to the machine frame, it being taken into account that mechanisms 1 and 3 must not be spaced further than one tube length apart, it being necessary for all of the tubes put through the process to be of one same length.

The spiral movement is ensured by devices 1 and 3, determining a perfect winding of the strip of fabric, so that the edges of the successive spirals are touching those of the following spiral without overlapping with one another.

According to FIG. 2, mechanisms 1 and 3 include claws 10 which can hold the tube 11 by its starting or final end. A circular component revolving on its axis, together with the traveling of the claws, determines the spiral movement of the tube. The claws hold the tube 11 in place along the outside so that the tube can be used continuously up to its separation with the similar element which is incorporated into the manufacturing line.

These claws 10, equipped with fingers actuated by mechanisms, are capable of holding both the tube which reaches the mechanism 1 as well as that which is thrust by the mechanism 3, and are affixed to the base 33 such that they turn on their own axis.

The traveling component is set into motion by the moving of the assembly which turns on a guide 20 affixed to the machine frame.

The length of the guides 20 must make it possible for the process to be performed continuously without halting, and this mechanism will obviously drag the tube 11 in the case of using some claws 10 as a mechanism 1, or will thrust it in the case of being used as mechanism 3.

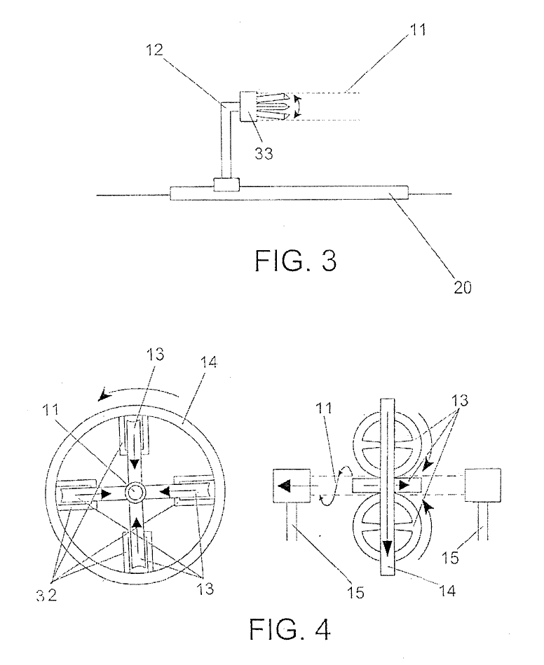

In FIG. 3, another embodiment is shown of mechanisms 1 and 3 responsible for the spiral movement of the tubular bodies, showing a similar functioning identical to that which is shown in FIG. 2, the only difference being that the claws 12 hold the tube on its inside.

The mechanism shown in FIGS. 2 and 3 will solely work if they are located facing the tube end 11.

In FIG. 4, another embodiment of the invention in question is shown corresponding to mechanisms 1 and 3 responsible for the spiral movement of the tubular bodies, in which the tube 11 is shown moved by working wheels 13 and 14, it necessarily being said that the wheels 13 are located on the inside of the circular body 14 at a 90°-angle to the inside area of the wheel 14, consequently being configured as four internal wheels 13 which make contact with the outside of the tube, turning such that they propel the tube in a traveling movement, while the wheel 14, which incorporates the four wheels 13 supported on the guide-supports 32 which are located in the area on the inside of the circular body constituting the wheels positioning the elements, turns on its own axis and is in charge of the rotating movement of the tubular body configured as a tube 11 supported by guide-supports 15.

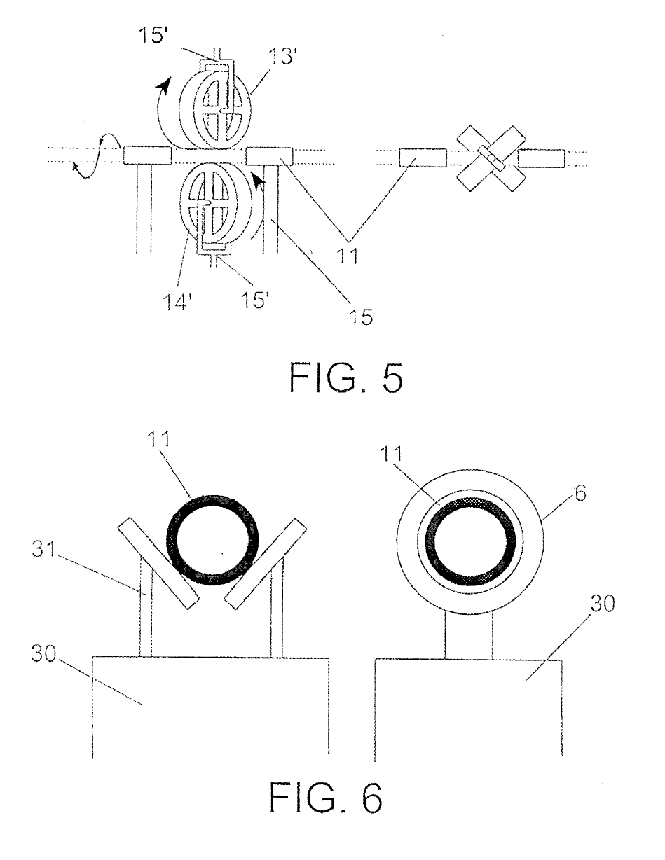

FIG. 5 shows another embodiment of the mechanisms 1 and 3 responsible for the movement of the tubular bodies, in which the two wheels 13′ and 14′, affixed to the frame of the machine by means of guide-supports 15′, are slanted appropriately to the tube center line, turning in a direction such as to generate the moving of the tube 11.

Again, in following with FIG. 1, a heat source 4 is seen to exist, which can be substituted by an extruder of the same polyolefin of which the tube 11 is comprised.

Number 2 shows the cutting device, located following the station 5, where the covered tubes are appropriately cut to their original length, in the area where the end and beginning of the tubes which have been put in one after the other to be covered coincide.

This cutting device 2, affixed to the machine frame, is placed after winding station 5 and prior to mechanism 1.

This placement can be achieved solely if the cutting device 2 is located prior to the movement mechanism 1 according to the direction in which the tube moves.

As has previously been stated, the invention in question is equipped with a mechanism 5 for winding the fabric around the outside of the tube 11, allowing for the winding in accordance with the existing spiral movement on the tube 11 along its entire center line, which must logically be located after the heat-generating element 4 or similar mechanism in relation to the direction in which the tube moves.

The guides affixed to the machine frame are indicated by number 6 and are structured so as to allow the other elements to operate.

FIG. 6 shows a front view of the support mechanisms 6 comprising the guides which may be configured into two slanted parts over which the tubular body 11 moves, or in the form of hollow cylinder through which the tubular body 11 also moves.

FIG. 1 again shows the tube 11 entering into the machine 30 through the side where the movement mechanism 3 is located, and the tube may be put into the machine manually or automatically using mechanisms readily apparent to those of skill in the art.

On the mechanism 3 which generates the movement of the tube 11 being set into motion, the tube travels lengthwise in a spiral movement. The tube 11 moves past the device used for generating heat 4 or for similar purposes and is subsequently subjected to the action of the mechanism 5 for the winding of the fabric covering, this being an action which is performed along the entire length of the tube 11 up to the point of losing contact with the movement device 3, it necessarily being said that prior to its losing contact with the device 3, the device 1 is already touching the starting end of the tube 11 and therefore the covering of the tubular body can continue, given that the device 1 becomes responsible for the spiral movement which continues ensuring a proper winding.

In following, a second tube is threaded into the process following the first tube 11, so that the space between the first and the second tube 11 is very small, affording the possibility of the winding operation not being interrupted in accordance with the actuation of the mechanisms 4 and 5, achieving a continuous process.

Device 2, that is to say, the cutting device, functions when the first tube 11 is already fully covered or wound with the fabric material, and the space between the ends of the two tubular bodies 11 are located exactly in front of the cutting mechanism 2.

Following the cutting operation, when the movement mechanism 1 stops functioning, the tube exits the process.

Said movement device 1, before the second tube loses contact with the device 3, ensures that there will be no interruption in the spiral movement of the tube, providing the process with continuity.

It will be recognized by one of ordinary skill in the art that changes may be made in the above-described embodiment of the invention without departing from the inventive concepts thereof. It is understood, therefore, that the invention is not limited to the particular embodiments disclosed, but is intended to encompass any modification which are within the scope and spirit of the invention.

In the claims:

1. A process for the manufacture of paint rollers comprised of a polyolefin core covered in a pile fabric, said process comprising supporting tubular bodies similar in length made from polyolefins while generating a lengthwise traveling movement and rotating movement of the tubular bodies along the center line of the tube, resulting in a spiral movement, heating and softening the surface of the tubular body, spirally winding a fabric covering on the tubular body softened on the surface, further generating traveling and rotating movement of the tubular body, and cutting the existing fabric covering crosswise between the adjacent ends of two tubular bodies.

2. The process as per claim 1, wherein said further generating begins to function on a specific tube prior to the end of the length of the tube being acted upon by said generating, and further comprising a prior step of feeding the tubes manually or automatically.

3. The process as per claim 1, wherein the heating and softening is performed by extruding the polyolefins as the tubular bodies.

4. The process as per claim 1, wherein the step of generating and the step of further generating include engaging each tube by plural claws which are turning on their own axis for the purpose of moving the tubular body spirally along its entire center line.

5. The process as per claim 1, wherein the steps of generating and further generating include engaging the surface of the tubes by working wheels located inside a circular body, the wheels coming into contact with the outside surface of the tube.

6. The process as per claim 1, wherein the steps of generating and further generating include engaging the surface of the tubes by at least one wheel angularly positioned with respect to the center line of the tubes so as to provide spiral movement of the tubes.

7. Machine for the manufacture of paint rollers comprised of a polyolefin core covered in a pile fabric, said machine comprising means for supporting tubular bodies similar in length made from polyolefins, a movement mechanism at one end of the machine for generating a lengthwise traveling movement and rotating movement of the bodies along the center line of the tube, resulting in a spiral movement, a heat generating mechanism softening the surface of the tubular body, a mechanism generating a spiral winding of a fabric covering on the softened tubular body, a further movement mechanism located on the opposite end of the machine for generating further lengthwise traveling movement and rotating movement of the bodies along the center line of the tube, and a cutting mechanism cutting the existing fabric covering crosswise between adjacent ends of two tubular bodies.

8. The machine as per claim 7, wherein said means for supporting comprises two slanted parts through which the tubular body moves.

9. The machine as per claim 7, wherein said means for supporting comprises hollow cylindrical bodies through which the tubular body moves.

10. The machine as per claim 7, wherein said movement mechanism begins to function prior to the end of the length of the tube acted upon by the further movement mechanism, and further comprising means for feeding the tubes to the means for supporting manually or automatically.

11. The machine as per claim 7, wherein the heat-generating mechanism is a polyolefin extruder.

12. The machine as per claim 7, wherein said movement and the further movement mechanisms comprise claws engaging the tubes and turn on their own axis for moving the tubular body spirally along its entire center line.

13. The machine as per claim 12, wherein said claws engage the tube around the outside of the tube.

14. The machine as per claim 12, wherein said claws engage the tube inside the tube.

15. The machine as per claim 7, wherein the movement and the further movement mechanisms comprise a circular body rotatably mounted coaxial to the center line of the tubes and working wheels rotatably located inside the circular body in contact with the outside surface of the tube.

16. The machine as per claim 7, wherein the movement and the further movement mechanisms comprise wheels rotatably mounted and appropriately slanted to the center line of the tube engaging the tube and providing spiral movement.
